(19) United States
(12) Patent Application Publication
(10) Pub. No.: US 2006/0220848 A1
(43) Pub. Date: Oct. 5, 2006

(54) Sensor anti-theft security tag

(76) Inventor: Hillel Tropper, Brooklyn, NY (US)

Correspondence Address: Bernard Malina;Malina & Associates, P.C., 60 East 42nd Street, New York, NY, 10165, US

(21) Appl. No.: 11/086,173

(22) Filed: Mar. 22, 2005

(51) Int. Cl. G08B 13/14

(52) U.S. Cl. 340/568.1

(57) ABSTRACT

A security tag includes an integrally formed base portion and a cover portion which are connected by a hinge portion. The base portion and the cover portion define cavities which are in a facing relationship when the cover portion is closed on the base portion. A flexible lanyard is connected to the base portion for connection of the security tag to various items of merchandise. A magnetic-type of sensor device may be mounted.

### FIELD OF THE INVENTION

The present invention relates generally to the field of security devices for the prevention of theft and more particularly, to a sensor anti-theft security tag.

### DESCRIPTION OF THE PRIOR ART

The prior art related to security tags includes the following U.S. Patents.

U.S. Patent Application Publication US2003/0160697A1 to Sedon et al. for a “Theft Deterrent Device” shows a base, a plug and a cable that is selectively connected to the base and the plug. The plug may be locked to the base to form a closed loop that may be used to hold merchandise.

U.S. Pat. No. 5,191,314 to Ackerman et al. for a “Combination Anti-Theft Lock and Alarm” shows a housing, an audible alarm and alarm circuit located within the housing and a flexible electrically conductive locking cable having a first end attached to the housing and a second end which is detachably connected to the housing. The alarm is activated in the event that the housing is cut on the cable or the cable is severed or jumped by a shunt wire.

U.S. Pat. No. 6,712,275B1 to Borg for a “UPC Identification Device” shows a label and a tail portion for attaching the device to a product. The tail portion is attached to a product by expanding the distal portion thereof or by forming a loop. The label includes a flat portion on which UPC information is affixed.

Despite the developments of the prior art, there remains a need for a sensor anti-theft security gag.

### OBJECTS AND SUMMARY OF THE INVENTION

It is an object of the present invention to provide a sensor anti-theft security tag which contains and conceals a sensor device.

Another object of the present invention is to provide a sensor anti-theft security device which can be easily attached to various articles of merchandise.

Another object of the present invention is to provide a sensor anti-theft security tag which provides a cavity for a sensor device.

Yet another object of the present invention is to provide a sensor anti-theft security tag which can be easily manufactured in volume resulting in a low unit cost.

The foregoing and other objects and advantages of the invention will appear more clearly hereinafter.

In accordance with the invention, a sensor anti-theft security tag includes an integrally formed member which includes a base portion and a cover portion. The base portion includes a pair of side panels and a pair of end panels which form a generally rectangular cavity. The side panels each include a pair of integrally formed pockets. The cover includes a rim which has four projecting portions which fit one each into the pockets while the rim fits into the rectangular cavity.

The interlocking of the rim with the side and end panels and the interlocking of the projecting portions with the pockets results in a secure closure between the cover portion and the base portion.

A strong flexible cord forms a loop having ends located in the cavity formed by the base and the cover. These ends of the cord include fittings which prevent removal of the cord thereby providing a secure means of attachment.

### DESCRIPTION OF THE DRAWINGS

Other important objects and advantages of the invention will be apparent from the following detailed description, taken in connection with accompanying drawings in which:

FIG. 1 is an overall perspective view of a sensor anti-theft security tag according to the present invention;

FIG. 2 is a top plan view taken along the line 2-2 of FIG. 1;

FIG. 3 is an end elevation view taken along the line 3-3 of FIG. 1;

FIG. 4 is another end elevation view taken along the line 4-4 of FIG. 1;

FIG. 5 is a top plan view showing the sensor anti-theft security tag of FIG. 1 in the open configuration;

FIG. 6 is a cross-sectional view taken along the line 6-6 of FIG. 5;

FIG. 7 is a cross-sectional view taken along the line 7-7 in FIG. 5;

FIG. 8 is a cross-sectional view taken along the line 8-8 of FIG. 1;

FIG. 9 is a cross-sectional view similar to FIG. 6 showing an alternative embodiment of the invention;

FIG. 10 is an end view of the cover of the embodiment shown in FIG. 9 taken along the line 10-10 of FIG. 9; and

FIG. 11 is a cross-sectional view taken along the line 11-11 of FIG. 9.

### DETAILED DESCRIPTION OF THE INVENTION

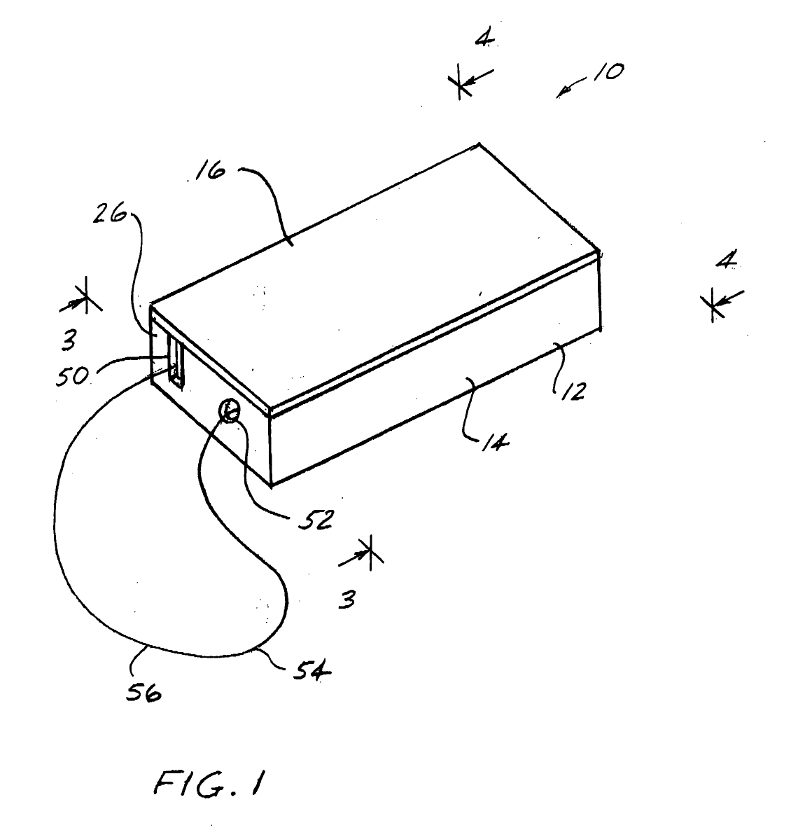

With reference to the drawings, wherein like reference numbers designate like or corresponding parts throughout, there is shown in FIG. 1 a sensor anti-theft security tag 10 mode according to the present invention which includes an integrally formed member 12 having a base 14 and a cover 16.

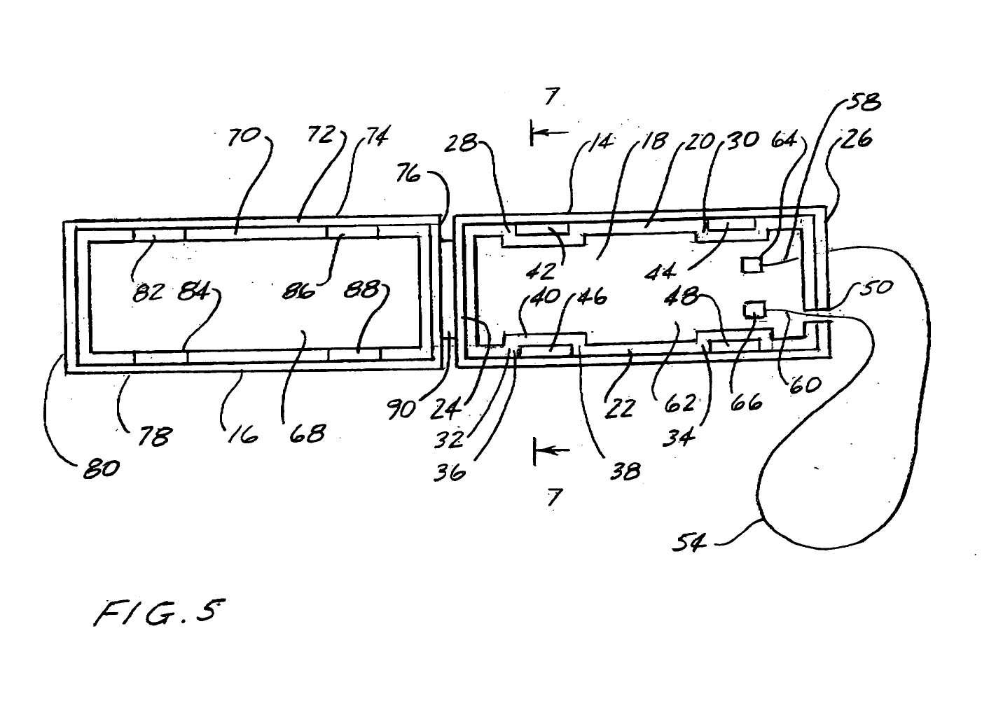

As is best shown in FIG. 5, the base 14 includes a bottom panel 18, a pair of spaced apart side panels 20, 22 and a pair of spaced apart end panels 24, 26. The bottom panel 18, side panels 20, 22 and end panels 24, 26 have the overall configuration of an open generally rectangular container or cavity 62.

Each of the side panels 20, 22 has a pair of integrally formed pockets 28, 30, 32, 34. The pockets 28, 30, 32, 34 each have a pair of spaced apart end portions 26, 28 and a wall portion 40. The end portions 36, 38 and the wall portions 40 form a generally rectangular cavity 42, 44, 46, 48 which is defined by the wall portions 40, the end portions 36, 38 and the bottom panel 18.

The end panel 26 includes a slot 50 and an aperture 52. A strong and flexible cord or lanyard 54 passes through the aperture 52 and through the slot 50 thereby forming a loop 56 as is shown in FIG. 5. The ends 58, 60 of the lanyard which are disposed within the cavity 62 defined by the base 14 each include a fitting 64, 66 of a selected size such that the fittings 64, 66 cannot pass through either the slot 50 or the aperture 52.

A preferred material for the cord or lanyard 54 has been found to be a thin metal wire rope. This material combines the desirable properties of flexibility and a high degree of mechanical strength which prevents unauthorized cutting or tampering.

The cord 54 facilitates the attachment of the sensor anti-theft security tag 10 according to the present invention to various items of merchandise in a manner which resists unauthorized removal or tampering.

The cover 16 includes a cover panel 68 and a generally rectangular rim 70. A flange portion 72 is formed between the peripheral edges 74, 76, 78, 80 of the cover 16 and the rim 70. The width of the flange portion 72 is generally equal to the thickness of the side and end panels 20, 22, 24, 26 enabling the rim 70 to project into the cavity 62. The rim 70 includes four projecting portions 82, 84, 86, 88. The projecting portions 82, 84, 86, 88 matches the proportions and spacing of the cavities 42, 44, 46, 48 thereby enabling the projecting portions 82, 84, 86, 88 to project into the cavities 42, 44, 46, 48 when the cover 16 is closed.

The interlocking of the rim 70 with the cavity 62 and the interlocking of the projecting portions 82, 84, 86, 88 with the cavities 42, 44, 46, 48 formed in the base 14 result in the cover 16 forming a tight and secure closure with the base 14.

The base 14 and the cover 16 are connected by an integrally formed hinge portion 90. The hinge portion 90 has a reduced thickness relative to the bottom panel 18 and the cover panel 68 of the cover 16 and the base 14. This reduced thickness results in a flexible connection between the cover 16 and the base 14.

The cover 16, the base 14 and the hinge portion 90 are preferably formed as an integrally molded unit which is formed of a moldable plastic material.

The sensor anti-theft security tag 10 according to the present invention can be used with a range of sensor devices which fit into the cavity 62 defined by the base 14 and the cover 16. A preferred sensor has been found to be a magnetic type sensor manufactured by Tyco Safety Products under the trade names SENSORMATIC ULTRA-STRIP III label 92. These labels incorporate a magnetic bias element within a sealed plastic case. The overall dimensions are: label length 45.21 mm (1.78″)
label width 10.67 mm (0.420″)
label thickness 1.89 mm (0.074″)

The labels are typically manufactured with an adhesive layer which is protected by a release liner. In use, the release liner is removed exposing the adhesive layer 94 and the label 92 is attached to the inner surface 96 of the cover panel 68.

Adhesive may be applied to the projecting portions 82, 84, 86, 88 to create a permanent closure of the cover 16 and the base 14.

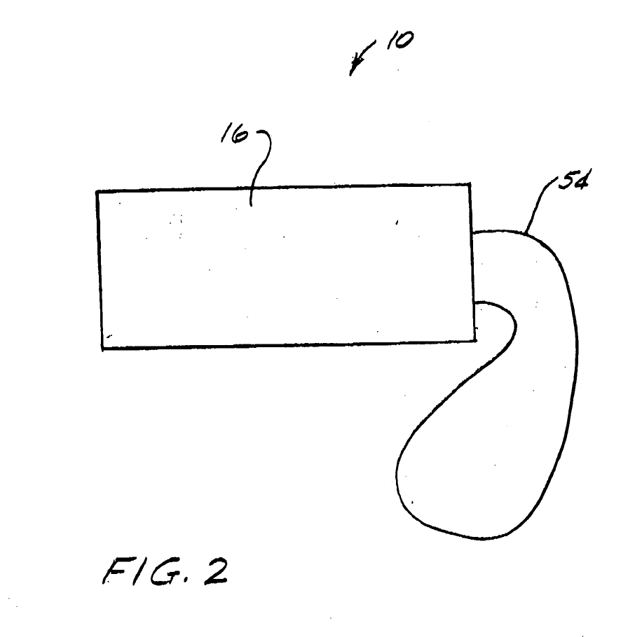

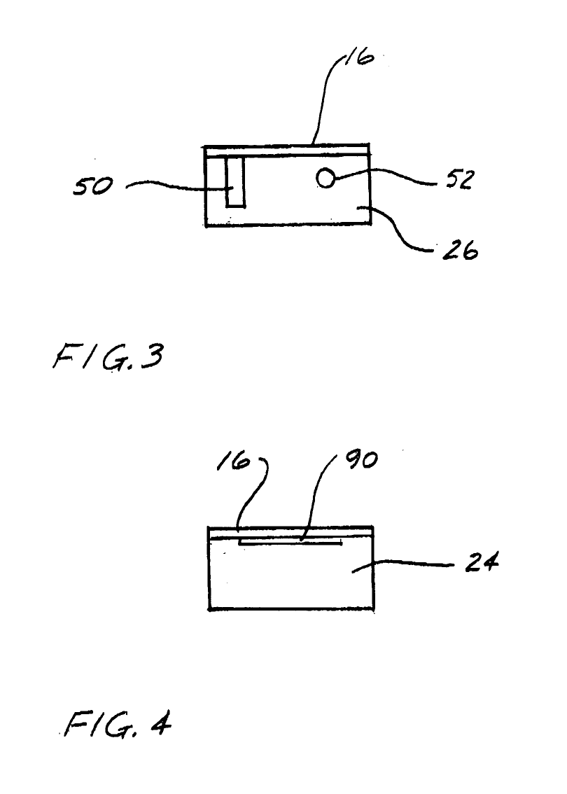

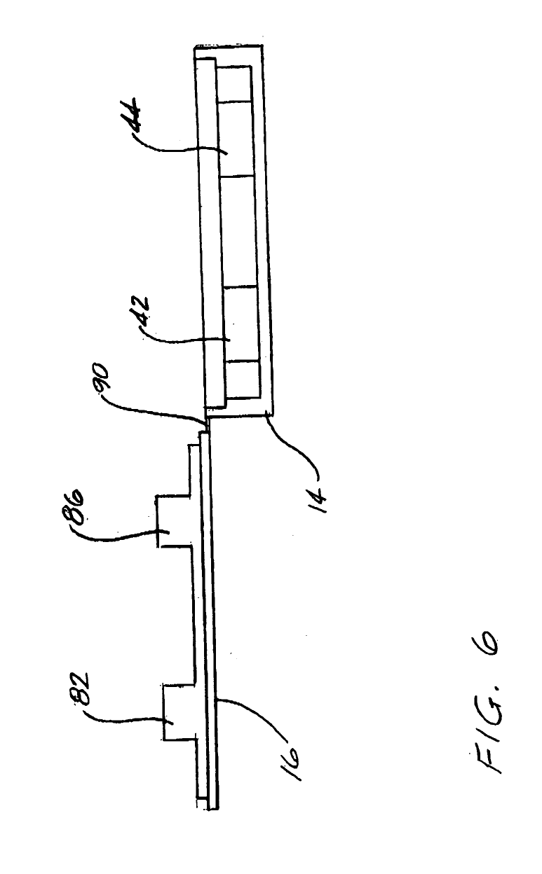

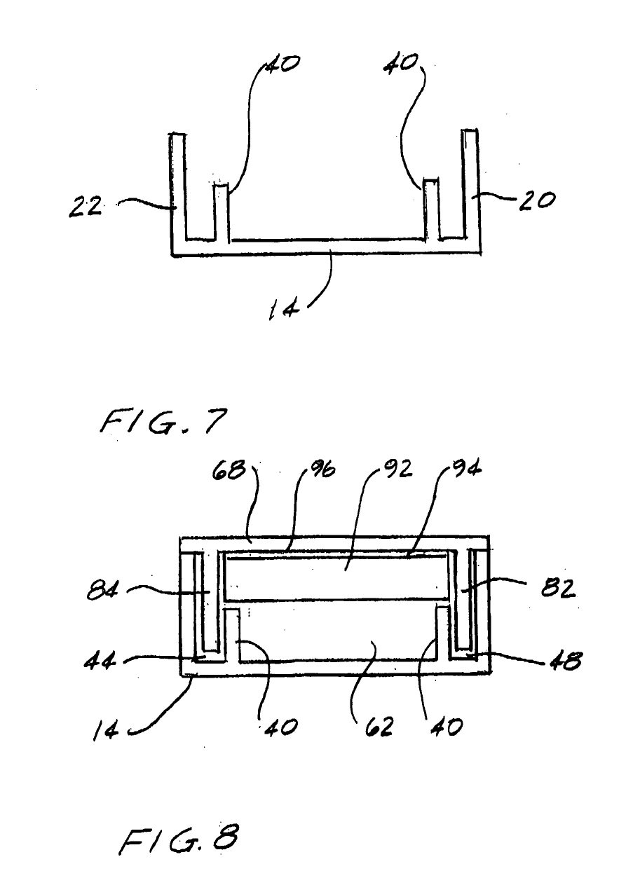

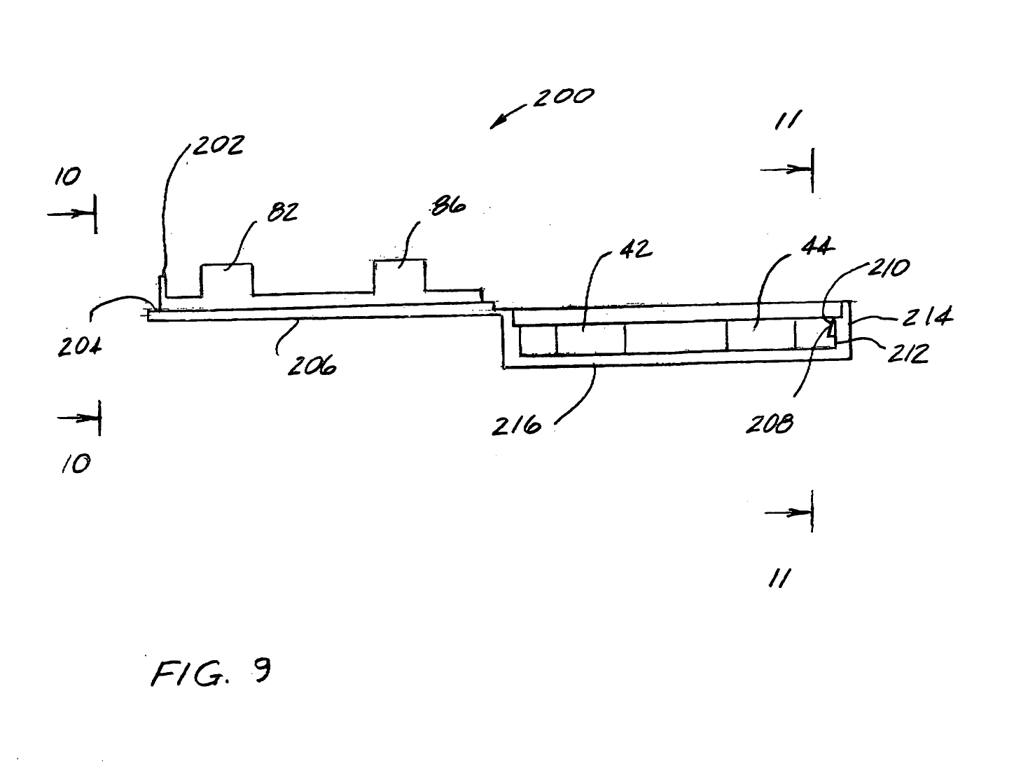

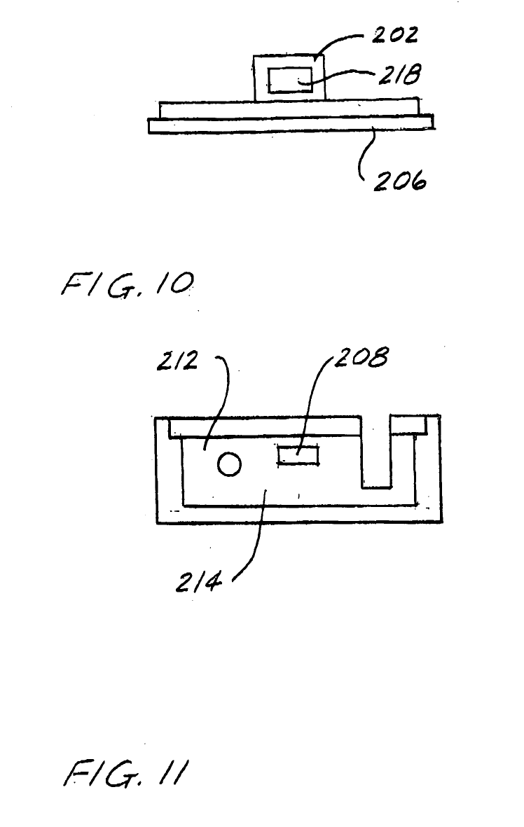

FIGS. 9-11 show an alternative embodiment of the invention 200 which is generally identical to the embodiment 10 shown in FIGS. 1-8 with the exception that a latch portion 202 has been added to the end 204 of the cover 206. In addition, a tongue portion 208 with an inclined surface 210 has been added to the inside 212 surface of the end panel 214.

When the cover 206 is closed on the base 216, the projecting members 82, 84, 86, 88 project into the cavities 42, 44, 46, 48 as previously described. In addition, the aperture 218 in the latch portion 202 engages the tongue portion 208. The engagement of the latch portion 202 and the tongue portion 208 prevents opening of the cover 206.

The foregoing specific embodiments of the present invention as set forth in the specification herein are for illustrative purposes only. Various deviations and modifications may be made within the spirit and scope of this invention, without departing from a main theme thereof.

What is claimed is:

1. A sensor anti-theft security tag comprising:
a base portion defining a base cavity;
a cover portion defining a cover cavity;
a hinge portion connecting said base portion and said cover portion with said base cavity and said cover cavity in a facing relationship with said base portion and said cover portion forming an interlocking closure and a flexible lanyard member connected to said base portion.

2. The sensor anti-theft cavity tag as claimed in claim 1 further comprising:
an aperture portion formed on said base portion; and
a slotted portion formed on said base portion, with said lanyard member having a pair of intermediate portions disposed passing, one each, through said aperture portion and through said slotted portion and disposed projecting into said base cavity.

3. The sensor anti-theft security tag as claimed in claim 1 further comprising:
a plurality of pocket portions defined in said loose portion; and
a plurality of projecting portions disposed projecting from said cover portion and disposed interlocking with said pocket portions.

4. The sensor anti-theft security tag as claimed in claim 3 wherein said pocket portions each define a rectangular cavity.

5. The sensor anti-theft security tag as claimed in claim 3 wherein said projecting portions comprise rectangular projecting portions.

6. The sensor anti-theft security tag as claimed in claim 1 wherein said cover portion further comprises a rim portion.

7. The sensor anti-theft security tag as claimed in claim 6 wherein said rim portion is disposed to project into said base cavity.

8. The sensor anti-theft security tag as claimed in claim 1 further comprising enlarged end portions formed on said flexible lanyard member.

9. The sensor anti-theft security tag as claimed in claim 1 further comprising a sensor unit with said sensor unit mounted on said cover cavity.

10. The sensor anti-theft security tag as claimed in claim 9 wherein said sensor unit comprises a magnetic-type sensor unit.

11. A sensor anti-theft security tag comprising:
a base portion comprising a base panel;
a plurality of panels projecting from said base panel and defining a cavity in combination with said base panel;
a cover portion;
a plurality of projections with said projections disposed projecting from said cover portion and interlocking with said base portion a hinge portion.

12. The sensor anti-theft security tag as claimed in claim 1 further comprising a latch assembly with said latch assembly locking said cover portion and said base portion.
